(19) United States
(12) Patent Application Publication
(10) Pub. No.: US 2016/0152754 A1
(43) Pub. Date: Jun. 2, 2016

(54) Reaction Resin Composition and Use Thereof

(71) Applicant: HILTI AKTIENGESELLSCHAFT, Schaan (LI)

(72) Inventor: Armin PFEIL, Kaufering (DE)

(21) Appl. No.: 14/904,310

(22) PCT Filed: Jul. 9, 2014
(86) PCT No.: PCT/EP2014/064687

§ 371 Date: Jan. 11, 2016

(30) Foreign Application Priority Data
Sep. 7, 2013 (EP) 13175674.4

(51) Int. Cl. C08F 222/10; C08K 3/00; C08F 220/36; C08K 5/00; C08K 5/3435; C08F 220/28

(52) U.S. Cl. CPC C08F 222/1006; C08K 5/3435; C08F 220/28; C08F 220/36; C08K 5/0008; C08K 3/0033; C08F 2222/1013; C08F 2220/281; C08F 2220/343

(57) ABSTRACT

A reaction-resin composition having a resin component which contains a radically polymerizable compound and having an initiator system which contains an α-halocarboxylic acid ester and a catalyst system that comprises a copper(I) salt and at least one nitrogen-containing ligand, and the use thereof for construction purposes are described.

The present relation relates to a radically curable reaction-resin composition having a resin component and an initiator system that comprises an initiator and a catalyst system, which is able to form in situ a transition-metal complex as catalyst; as well as the use thereof for construction purposes, particularly for the anchoring of anchoring elements in bore holes.

The use of reaction-resin compositions based on unsaturated polyester resins, vinyl ester resins, or epoxy resins as bonding and adhesive agents has long been known. These are two-component systems, with one component containing the resin mixture and the other component containing the curing means. Other common components such as fillers, accelerators, stabilizers, [and] solvents including reactive solvents (reactive diluents) can be contained in one and/or the other component. By mixing the two components, the reaction is then set in motion, forming a cured product.

The mortar masses which are to be used in chemical fastening technology are complex systems subject to particular requirements such as, for example, the viscosity of the mortar mass, curing and full curing in a relatively broad temperature range (usually −10° C. to +40° C.), the inherent stability of the cured mass, adhesion to different substrates and ambient conditions, load values, creep resistance, and the like.

Two systems are generally used in chemical fastening technology. One is based on radically polymerizable, ethylenically unsaturated compounds, which, as a rule, are cured using peroxides, and one is epoxide-amine based.

Organic, curable two-component reaction-resin compositions based on curable epoxy resins and amine-curing agents are used as adhesives, spackling masses to fill cracks, and, among other things, to fasten construction elements such as anchor rods, concrete iron (reinforcing bars), screws, and the like in bore holes. Mortar masses of this kind are known from EP 1 475 412 A2, DE 198 32 669 A1, and DE 10 2004 008 464 A1.

One disadvantage of the known epoxide-based mortar masses is the use of often considerable quantities of corrosive amines as curing agents such as xylene diamine (XDA), particularly m-xylene diamine (mXDA; 1,3-benzenedimethanamine), and/or aromatic alcohol compounds such as free phenols—e.g., bisphenol A, which can involve a health risk for users. Very large quantities—i.e., up to 50%—of those compounds are sometimes contained in the individual components of multicomponent mortar masses, so a labeling requirement often applies to the packaging, leading to less acceptance by users of the product. Limit values have been introduced in some countries in recent years for the content of mXDA or bisphenol A that is allowed in products or that must be labelled or even may be contained in products.

Radically curable systems, particularly systems curable at room temperature, need so-called radical starters, also known as initiators, so that the radical polymerization can be induced. Due to their properties, the curing agent composition described in application DE 3226602 A1, which includes benzoyl peroxide as radical starter and an amine compound as an accelerator, and the curing agent composition described in application EP 1586569 A1, comprising a perester as curing agent and a metal compound as accelerator, have caught on in the field of chemical-fastening technology. These curing agent compositions allow fast and very complete curing, even at very low temperatures down to −30° C. These systems are also robust with regard to the mixing ratios of resin and curing agent. This makes them appropriate for use under conditions on a construction site.

The disadvantage of these curing-agent compositions, however, is that peroxides must be used as radical starter in both cases. They are heat-sensitive and react very responsively to impurities. This leads to considerable limitations in the formulation of pasty curing-agent components, particularly for injection mortars, with regard to storage temperatures, storage stabilities, and the choice of appropriate components. To allow the use of peroxides such as dibenzoyl peroxide, peresters, and the like, phlegmatization agents such as phthalates or water are added to stabilize them. They act as softeners, thereby significantly impairing the mechanical strength of the resin mixtures.

These known curing agent compositions are also detrimental to the extent that they must contain considerable amounts of peroxide, which is problematic because products that contain peroxide above a concentration of 1%, such as dibenzoyl peroxide, must be labeled as sensitizing in some countries. The same applies to the amine accelerators, some of which are also subject to labeling requirements.

Very few attempts have hitherto been made to develop peroxide-free systems based on radically polymerizable compounds. A peroxide-free curing agent composition for radically polymerizable compounds that contains a 1,3-dicarbonyl compound as curing agent and a manganese compound as accelerator and use thereof for reaction-resin compositions based on radically curable compounds is known from DE 10 2011 078 785 A1. However, that system tends not to fully cure sufficiently under certain conditions, leading to reduced performance by the cured mass, particularly for use as a plugging mass; so, it is generally possible to use it as a plugging mass, but not for applications requiring reliable, very high load values.

It is also disadvantageous in the two described systems that a defined ratio of resin components and curing agent components (also briefly referred to below as mixing ratio) must be maintained for each of them so that the binder can completely cure and the required properties of the cured masses can be achieved. Many of the known systems are not very robust where the mixing ratio is concerned and, in some cases, react very responsively to fluctuations in the mixture, which affects the properties of the cured masses.

Another possibility for initiating radical polymerization without the use of peroxides is provided by the ATRP (atom transfer radical polymerization) method, which is often used in macromolecular synthesis chemistry. It is assumed that this involves a “living” radical polymerization, although no limitation is intended as a result of the description of the mechanism. In these methods, a transition-metal compound is transformed using a compound that has a transferrable atom group. When this is done, the transferrable atom group is transferred to the transition-metal compound, as a result of which the metal is oxidized. In this reaction, a radical is formed that is added to ethylenic unsaturated groups. The transfer of the atom group to the transition-metal compound is reversible, however, so the atom group is transferred back to the growing polymer chain, as a result of which a controlled polymerization system is formed. This reaction control is described by J. S. Wang, et al., J. Am. Chem. Soc., vol. 117, pp. 5614-5615 (1995), [and] by Matyjaszewski, Macromolecules, vol. 28, pp. 7901-7910 (1995). The publications WO 96/30421 A1, WO 97/47661 A1, WO 97/18247 A1, WO 98/40415 A1, and WO 99/10387 A1 also disclose variants of the ATRP discussed above.

ATRP was of scientific interest for a long time and is substantially used for targeted control of the properties of polymers and to adjust them to the desired applications. These include control of the particle size, structure, length, weight, and weight distribution of polymers. The structure of the polymer, the molecular weight, and the molecular weight distribution can be controlled accordingly. This is also increasing the economic interest in ATRP. For example, U.S. Pat. Nos. 5,807,937 and 5,763,548 describe (co)polymers produced using ATRP, which are useful for a multiplicity of applications, such as dispersants and surface-active substances.

However, ATRP has not previously been used to carry out polymerization in situ, such as on a construction site under the conditions that prevail there, as is necessary for construction application[s], e.g., mortar, adhesive, and plugging masses. The requirements that those applications impose on polymerizable compositions, namely initiation of polymerization in the temperature range between −10° C. and +60° C., inorganically filled compositions, adjustment of a gel time with subsequent fast polymerization of the resin component (which is as complete as possible), packaging as single- or multicomponent systems, and the other known requirements for the cured mass have not previously been taken into account in the comprehensive literature on ATRP.

The object of the invention is thus to provide a reaction-resin composition for mortar systems as described above, which does not have the specified disadvantages of known systems, which can be packaged in particular as a two-component system, is storage-stable over several months, and reliably cures—i.e., is cold-curing, at the usual application temperatures for reaction-resin mortar, i.e., between −10° C. and +60° C.

The inventor has surprisingly discovered that the object can be achieved in that ATRP initiator systems are used as radical initiator for the reaction-resin compositions based on radically polymerizable compounds that are described above.

The following explanations of the terminology used herein are considered useful for better understanding of the invention. In the sense of the invention:
“Cold-curing” means that the polymerization, also referred to synonymously herein as “curing,” of the two curable compounds can be started at room temperature without additional energy input—for example, the addition of heat—as a result of the curing means contained in the reaction-resin compositions, optionally in the presence of accelerators, and also exhibit[s] sufficient full curing for the planned applications.
“Separated in a reaction-inhibiting manner” means that a separation between compounds or components is achieved in such a way that a reaction between them cannot take place until the compounds or components are brought into contact with each other, for example, by mixing; a reaction-inhibiting separation as a result of (micro)encapsulation of one or more compounds or components is also conceivable.
“Curing means” means substances that cause the polymerization (curing) of the base resin.
“Aliphatic compound” means an acyclic or cyclic, saturated or unsaturated hydrocarbon compound that is not aromatic (PAC, 1995, 67, 1307; Glossary of class names of organic compounds and reactivity intermediates based on structure (IUPAC Recommendations 1995)).
“Accelerator” means a compound able to accelerate the polymerization reaction (curing), which is used to accelerate the formation of the radical starter.
“Polymerization inhibitor,” also referred to synonymously herein as “inhibitor,” means a compound able to inhibit the polymerization reaction (curing), which is used to prevent the polymerization reaction and, therefore, an undesired premature polymerization of the radically polymerizable compound during storage (often referred to as stabilizer), and which is used to delay the start of the polymerization reaction immediately after the addition of the curing agent; to achieve the aim of storage stability, the inhibitor is commonly used in such small quantities that the gel time is not influenced; to influence the time point of the start of the polymerization reaction, the inhibitor is commonly used in quantities such that the gel time is influenced.
“Reactive diluent” means liquid or low-viscosity monomers and base resins, which dilute other base resins or the resin component, thereby imparting the viscosity necessary for their application; contain functional groups capable of reacting with the base resin; and, during polymerization (curing), predominantly become a component of the cured mass (mortar).
“Gel time”: For unsaturated polyester or vinyl resins, which are commonly cured using peroxides, the time for the curing phase of the resin corresponds to the gel time, during which the temperature of the resin rises from +25° C. to +35° C.; this corresponds approximately to the time period during which the fluidity or viscosity of the resin is still in a range such that the reaction resin or the reaction-resin mass can still be easily handled or processed.
“Two-component system” means a system that contains two components stored separately from each other—generally a resin component and a curing agent component—in such a way that curing of the resin component does not occur until after mixing of the two components.
“Multicomponent system” means a system that contains three or more components stored separately from each other, so that curing of the resin component does not occur until after mixing of all components.
“(Meth)acryl . . . / . . . (meth)acryl . . . ” means that both the “methacryl . . . / . . . methacryl . . . ” and the “acryl . . . / . . . acryl . . . ” compounds are to be included.

The inventor has discovered that radically polymerizable compounds having a combination of specific compounds, as they are used for the initiation of the ATRP, can be polymerized under the reaction conditions that prevail for construction applications. This makes it possible to provide a reaction-resin composition that is cold-curing; that fulfills the requirements for reaction-resin compositions for use as mortar, adhesive, or plugging masses; and that in particular is packaged as two- or multicomponent system, [and] is storage-stable.

A first object of the invention is thus a reaction-resin composition having a resin component that contains a radically polymerizable compound and having an initiator system that contains an α-halocarboxylic acid ester and a catalyst system that comprises a copper(I) salt and at least one nitrogen-containing ligand.

Reaction-resin compositions can thus be provided that are free of peroxide and critical amine compounds and are thus no longer subject to a labeling requirement. Furthermore, the compositions no longer contain phlegmatizing agents functioning as softeners in the cured mass. Another advantage of the invention is that the composition, when it is packaged as a two-component system, allows any chosen ratio of the two components in relation to each other, with the initiator system being homogeneously dissolved in the components, so that only a low concentration of it is necessary.

The initiator system in accordance with the invention comprises an initiator and a catalyst system.

The initiator is advantageously a compound that has a halogen-hydrocarbon bond that, as a result of catalyzed homolytic cleavage, supplies C radicals that can start radical polymerization. To ensure a sufficiently long lifespan of the radical, the initiator must have substituents that can stabilize the radical, such as, for example, carbonyl substituents. The halogen atom exercises a further influence on initiation.

The primary radical formed from the initiator preferably has a similar structure to the radical center of the growing polymer chain. Thus, when the reaction-resin compositions are methacrylate resins or acrylate resins, α-halocarboxylic acid esters of isobutyric acid or propanoic acid are particularly appropriate. In individual cases, however, particular suitability should always be determined by experiments.

One class of compounds has been proven to be particularly appropriate for use of the reaction-resin composition as construction adhesive, mortar, or plugging mass, particularly for mineral substrates. Therefore, in accordance with the invention, the initiator is an α-halocarboxylic acid ester having the general formula (I)

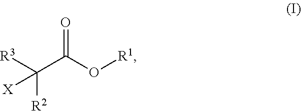

in which
X means chlorine, bromine, or iodine, preferably chlorine or bromine, particularly preferably bromine;
R¹ stands for a straight-chain or branched, optionally substituted C₁-C₂₀ alkyl group, preferably a C₁-C₁₀ alkyl group, or an aryl group; or for the residue of an acylated, branched trivalent alcohol, the residue of a completely or partially acylated, linear or branched, quadrivalent alcohol, the residue of a completely or partially acylated, linear pentavalent or hexavalent alcohol, the residue of a completely or partially acylated, linear or cyclical C₄-C₆ aldose or C₄-C₆ ketose, or the residue of a completely or partially acylated disaccharide, and isomers of those compounds;
R² and R³, independently of each other, stand for hydrogen, a C₁-C₂₀ alkyl group, preferably a C₁-C₁₀ alkyl group and more preferably C₁-C₆ alkyl group, or a C₃-C₈ cycloalkyl group, C₂-C₂₀ alkenyl or alkinyl group, preferably C₂-C₆ alkenyl group or alkinyl group, oxiranyl group, glycidyl group, aryl group, heterocyclyl group, aralkyl group, [or] aralkenyl group (aryl-substituted alkenyl groups).

Compounds of this kind and their production are known to those skilled in the art. In that regard, reference is made to the publications WO 96/30421 A1 and WO 00/43344 A1, whose content is hereby incorporated into this application.

Appropriate initiators include, for example C₁-C₆ alkyl esters of an α-halo-C₁-C₆ carbonic acid, such as α-chlorpropionic acid, α-brompropionic acid, α-chlor-iso-butyric acid, α-bromo-iso-butyric acid, and the like.

Esters of α-bromo-iso-butyric acid are preferred. Examples of appropriate a bromo-iso-butyric acid esters are: bis[2-(2′-bromo-iso-butyryloxy)ethyl]disulfide, bis[2-(2-bromo-iso-butyryloxy)undecyl]disulfide, α-bromo-iso-butyryl bromide, 2-(2-bromo-iso-butyryloxy)ethyl methacrylate, tert-butyl-α-bromo-iso-butyrate, 3-butynyl-2-bromo-iso-butyrate, dipentaerythritol hexakis(2-bromo-iso-butyrate), dodecyl-2-bromo-iso-butyrate, ethyl-α-bromo-iso-butyrate, ethylene bis(2-bromo-iso-butyrate), 2-hydroxyethyl-2-bromo-iso-butyrate, methyl-α-bromo-iso-butyrate, octadecyl-2-bromo-iso-butyrate, pentaerythritol tetrakis(2-bromo-iso-butyrate), poly(ethylene glycol)bis(2-bromo-iso-butyrate), poly(ethylene glycol)methylether-2-bromo-iso-butyrate, 1,1,1-tris(2-bromo-iso-butyryloxymethyl)ethane, 10-undecenyl 2-bromo-iso-butyrate.

The catalyst system in accordance with the invention comprises a copper salt and at least one ligand.

The copper must advantageously be able to participate in a single-electron redox process, have a high affinity to a halogen atom—particularly bromine—and should be able to reversibly increase its coordination number by one. It must also tend toward complex formation.

The ligand advantageously contributes to the solubility of the copper salt in the radically polymerizable compound to be used, to the extent the copper salt itself is not yet soluble and is able to adjust the redox potential of the copper with regard to reactivity and halogen transfer.

To allow the initiator to split off radicals that can initiate the polymerization of the radically polymerizable compounds, a compound is necessary that allows or controls, in particular accelerates, the splitting off. Using an appropriate compound, it becomes possible to provide a reaction-resin mix that cures at room temperature.

That compound is advantageously an appropriate transition-metal complex that is able to homolytically split the bond between the α-carbon atom and the halogen atom of the initiator, which is bonded to it. The transition-metal complex must also be able to participate in a reversible redox cycle with the initiator, a sleeping polymer chain end, a growing polymer chain end, or a mixture thereof.

In accordance with the invention, that compound is a copper(I) complex of the general formula Cu(I)—X.L, which is formed from a copper(I) salt and an appropriate ligand (L). However, copper(I) compounds are frequently very oxidation sensitive, and they can be transformed into copper(II) compounds merely by oxygen in the air.

If the reaction-resin mixture is produced—i.e., its components mixed—immediately before it is used, the use of copper(I) complexes in general is not critical. However, if storage-stable reaction-resin mixtures are to be prepared over a certain period of time, the stability of the copper(I) complex in relation to oxygen in the air or other components that may be contained in the reaction-resin mixture matters greatly.

To provide a storage-stable reaction-resin mixture, is it therefore necessary to use the copper salt in stable form. This can be achieved by using an oxidation-stable copper(I) salt such as 1,4-diazabicyclo[2.2.2]octane copper(I) chloride complex (CuCl.DABCO complex). In this context, “oxidation-stable” means that the copper(I) salt is sufficiently stable in relation to oxygen in the air and is not oxidized into higher-valent copper compounds. Activation of the oxidation-stable copper(I) salt will often be necessary to initiate the curing reaction.

This can be achieved, for example, by adding appropriate ligands, which displace the ligands/counterions of the copper(I) complex. The copper(I) complex is preferably, particularly with regard to storage stability, formed in situ from a copper(II) salt and an appropriate ligand. For that purpose, the initiator system also contains an appropriate reducing agent, and the copper(II) salt and the reducing agent are preferably separated from each other in a reaction-inhibiting manner.

Appropriate copper(II) salts are those that are soluble in the radically polymerizable compound that is used or in a solvent optionally added to the resin mixture, such as a reactive diluent. Copper(II) salts of this kind are, for example, Cu(II)(PF₆)₂; CuX₂, where X=Cl, Br, I, with CuX₂ being preferred and CuCl₂ or CuBr₂ being more preferred; Cu(OTf)₂ (-Otf=trifluoromethanesulfonate, CF₃SO₃); or Cu(II) carboxylate. Copper(II) salts that, as a function of the radically polymerizable compound that is used, can be dissolved in it without the addition of ligands are particularly preferred.

Appropriate ligands, particularly neutral ligands, are known from the complex chemistry of transition metals. They are coordinated with the coordination center under the effect of different bond types, e.g., σ-, π-, η-bonds. The choice of the ligands allows the reactivity of the copper(I) complex to be adjusted in relation to the initiator and allows the solubility of the copper(I) salt to be improved.

In accordance with the invention, the ligand is a nitrogen-containing ligand. The ligand is advantageously a nitrogen-containing ligand that contains one, two, or more nitrogen atoms such as mono-, bi-, or tridentate ligands.

Appropriate ligands are amino compounds having primary, secondary, and/or tertiary amino groups, with those having exclusively tertiary amino groups being preferred, or amino compounds having heterocyclic nitrogen atoms, which are particularly preferred.

Examples of appropriate amino compounds are: ethylene diaminotetraacetate (EDTA); N,N-dimethyl-N′,N′-bis(2-dimethylaminoethyl)ethylenediamine (Me6TREN); N,N′-dimethyl-1,2-phenyldiamine; 2-(methylamino)phenol; 3-(methylamino)-2-butanol; N,N′-bis(1,1-dimethylethyl)-1,2-ethandiamine or N,N,N′,N″,N″-pentamethyl-diethyl-enetriamine (PMDETA); and mono-, bi-, or tridentate heterocyclic electron-donor ligands such as those derived from unsubstituted or substituted heteroarenes such as furane, thiophene, pyrrole, pyridine, bipyridine, picolylamine, γ-pyrane, γ-thiopyrane, phenanthroline, pyrimidine, bis pyrimidine, pyrazine, indole, coumarin, thionaphthene, carbazole, dibenzofurane, dibenzothiophene, pyrazole, imidazole, benzimidazole, oxazole, thiazole, bis thiazole, isoxazole, isothiazole, quinoline, biquinoline, isoquinoline, biisoquinoline, acridine, chromane, phenazine, phenoxazine, phenothiazine, triazine, thianthrene, purine, bismidazole, and bisoxazoline.

Of those, 2,2′-bipyridine, N-butyl-2-pyridylmethanimine, 4,4′-di-tert-butyl-2,2′-dipyridine, 4,4′-dimethyl-2,2′-dipyridine, 4,4′-dinonyl-2,2′-dipyridine, N-dodecyl-N-(2-pyridylmethylene)amine, 1,1,4,7,10,10-hexamethyl triethylenetetramine, N-octadecyl-N-(2-pyridylmethylene)amine, N-octyl-2-pyridylmethanimine, N,N,N′,N″,N″-pentamethyl-diethylentriamine, 1,4,8,11-tetracyclotetradecane, N,N,N′,N′-tetrakis(2-pyridylmethyl)ethylenediamine, 1,4,8,11-tetramethyl-1,4,8,11-tetraazacyclotetradecane, tris[2-(diethylamino)ethyl]amine, or tris(2-methylpyridyl)amine are preferred, with N,N,N′,N″,N″-pentamethydiethyltriamine (PMDETA), 2,2′-bipyridine (bipy), or phenanthroline (phen) being more strongly preferred.

Contrary to the recommendations from the scientific literature, which as a rule describes a ratio of Cu:ligand=1:2 as optimum for the quantity of nitrogen-containing ligands to be used, the inventor has surprisingly discovered that the reaction-resin composition shows a much stronger reactivity—i.e., cures faster and fully cures better—when the nitrogen-containing ligand is added in excess. In that regard, “in excess” means that the amine ligand is indeed added in the ratio Cu:ligand=1:5, or even up to 1:10. What is decisive is that this excess does not in turn have a harmful effect on the reaction and the final properties.

Also contrary to the recommendations from the scientific literature, the inventor has surprisingly discovered that the reaction-resin composition, independent of the quantity used, shows a much stronger reactivity when the ligand is a nitrogen-containing compound having primary amino groups.

Accordingly, in a more preferred embodiment, the nitrogen-containing ligand is an amine having at least one primary amino group. The amine is advantageously a primary amine, which can be aliphatic, including cycloaliphatic, aromatic, and/or araliphatic, and can carry one or more amino groups (referred to below as polyamine). The polyamine preferably carries at least two primary aliphatic amino groups. The polyamine can also carry amino groups that are of secondary or tertiary character. Polyaminoamides and polyalkylene oxide polyamines or amine adducts, such as amine-epoxy resin adducts or Mannich bases, are just as appropriate. Amines containing both aromatic and aliphatic residues are defined as araliphatic.

Appropriate amines, without limiting the scope of the invention are, for example: 1,2-diaminoethane(ethylenediamine), 1,2-propandiamine, 1,3-propandiamine, 1,4-diaminobutane, 2,2-dimethyl-1,3-propandiamine (neopentane diamine), diethylaminopropylamine (DEAPA), 2-methyl-1,5-diaminopentane, 1,3-diaminopentane, 2,2,4- or 2,4,4-trimethyl-1,6-diaminohexane and mixtures thereof (TMD), 1-amino-3-aminomethyl-3,5,5-trimethylcyclohexane, 1,3-bis(aminomethyl)-cyclohexane, 1,2-bis(aminomethyl)cyclohexane, hexamethylenediamine (HMD), 1,2- and 1,4-diaminocyclohexane (1,2-DACH and 1,4-DACH), bis(4-aminocyclohexyl)methane, bis(4-amino-3-methylcyclohexyl)methane, diethylenetriamine (DETA), 4-azaheptane-1,7-diamine, 1,11-diamino-3,6,9-trioxundecane, 1,8-diamino-3,6-dioxaoctane 1,5-diamino-methyl-3-azapentane, 1,10-diamino-4,7-dioxadecane, bis(3-aminopropyl)amine, 1,13-diamino-4,7,10-trioxatridecane, 4-aminomethyl-1,8-diaminooctane, 2-butyl-2-ethyl-1,5-diaminopentane, N,N-Bis-(3-aminopropyl)methylamine, triethylenetetramine (TETA), tetraethylenepentamine (TEPA), pentaethylenehexamine (PEHA), bis(4-amino-3-methylcyclohexyl)methane, 1,3-benzenedimethanamine (m-xylylenediamine, mXDA), 1,4-benzenedimethanamine (p-xylylenediamine, pXDA), 5-(aminomethyl)bicyclo[[2.2.1]hept-2-yl]methylamine (NBDA, Norbornane diamine), dimethyl dipropylene triamine, dimethylaminopropyl-aminopropyl amine (DMAPAPA), 3-aminomethyl-3,5,5-trimethylcyclohexylamine (isophorondiamine (IPD)), diaminodicyclohexylmethane (PACM), mixed polycyclic amines (MPCA) (e.g., Ancamine® 2168), dimethyl diaminodicyclohexylmethane (Laromin® C260), 2,2-bis(4-aminocyclohexyl)propane, (3(4),8(9)bis(aminomethyl)dicyclo[5.2.1.0^{2,6}]decane (isomer mixture, tricyclic primary amines; TCD-diamine).

Polyamines such as 2-methylpentane diamine (DYTEK A®), 1-amino-3-aminomethyl-3,5,5-trimethylcyclohexane (IPD), 1,3-benzenedimethanamine (m-xylylendiamine, mXDA), 1,4-benzenedimethanamine (p-xylylendiamine, PXDA), 1,6-diamino-2,2,4-trimethylhexane (TMD), diethylenetriamine (DETA), triethylenetetramine (TETA), tetraethylenepentamine (TEPA), pentaethylenehexamine (PEHA), N-ethylaminopiperazine (N-EAP), 1,3-bisaminomethylcyclohexane (1,3-BAC), (3(4),8(9)bis(aminomethyl)dicyclo[5.2.1.0^{2,6}]decane (isomer mixture, tricyclic primary amines; TCD diamine), 1,14-diamino-4,11-dioxatetradecane, dipropylenetriamine, 2-methyl-1,5-pentandiamine, N,N′-dicyclohexyl-1,6-hexanediamine, N,N′-dimethyl-1,3-diaminopropane, N,N′-diethyl-1,3-diaminopropane, N,N-dimethyl-1,3-diaminopropane, secondary polyoxypropylene di- and triamines, 2,5-diamino-2,5-dimethylhexane, bis-(amino-methyl)tricyclopentadiene, 1,8-diamino-p-menthane, bis-(4-amino-3,5-dimethylcyclohexyl)methane, 1,3-bis(aminomethyl)cyclohexane (1,3-BAC), dipentylamine, N-2-(aminoethyl)piperazine (N-AEP), N-3-(aminopropyl)piperazine, piperazine, are preferred.

The amine can be added either alone or as a mixture of two or more of them.

To form the copper(I) complex, if a copper(II) salt is used, as described above, a reducing agent is used which is able to reduce the copper(II) to a copper(I) in situ.

Reducing agents that substantially allow reduction without the formation of radicals, which in turn can initiate new polymer chains, can be used. Appropriate reducing agents are ascorbic acid and its derivatives, tin compounds, reducing sugars (e.g., fructose), antioxidants [(such as those used to preserve food, e.g., flavonoids (quercetin), β-carotinoids (vitamin A), α-tocopherol (vitamin E)] phenolic reducing agents [such as propyl or octyl gallate (triphenol), butylhydroxyanisole (BHA), or butylated hydroxytoluene (BHT)], other preservatives for food (such as nitrites, propionic acids, sorbic acid salts, or sulfates). Additional appropriate reducing agents are SO₂, sulfites, bisulfites, thiosulfates, mercaptans, hydroxylamines and hydrazine and derivatives thereof, hydrazone and derivatives therefore, amines and derivatives thereof, phenols, and enols. The reducing agent can also be a transition metal M(0) in oxidation state zero. A combination of reducing agents can also be used.

In this context, reference is made to U.S. Pat. No. 2,386,358, whose content is hereby incorporated into this application.

The reducing agent is preferably chosen from among tin(II) salts of carbonic acids such as, for example, tin(II) octanoate, particularly tin(II)-2-ethylhexanoate, phenolic reducing agents, or ascorbic acid derivatives; with tin(II) octanoate, particularly tin(II)-2-ethylhexanoate, being particularly preferred.

In accordance with the invention, ethylenic unsaturated compounds, compounds having carbon-carbon triple bonds, and thiol-yne/ene resins, as known to a person skilled in the art, are appropriate as radically polymerizable compounds.

Of those compounds, the group of ethylenic unsaturated compounds is preferred, which includes styrene and derivatives thereof, (meth)acrylates, vinyl ester, unsaturated polyester, vinyl ether, allyl ether, itaconates, dicyclopentadiene compounds, and unsaturated fats, of which in particular unsaturated polyester resins and vinyl ester resins are appropriate and are described as examples in the publications EP 1 935 860 A1, DE 195 31 649 A1, WO 02/051903 A1, and WO 10/108939 A1. Vinyl ester resins are most preferred due to their hydrolytic stability and excellent mechanical properties.

Examples of appropriate unsaturated polyesters that can be used in the resin mixture in accordance with the invention are divided into the following categories, as classified by M. Malik, et al. in J. M. S.—Rev. Macromol. Chem. Phys., C40(2 and 3), pp. 139-165 (2000):

(1) Ortho resins: These are based on phthalic acid anhydride, maleic acid anhydride, or fumaric acid and glycols such as 1,2-propylene glycol, ethylene glycol, diethylene glycol, triethylene glycol, 1,3-propylene glycol, dipropylene glycol, tripropylene glycol, neopentyl glycol, or hydrogenated bisphenol A.

(2) Iso resins: These are produced from isopthalic acid, maleic acid anhydride, or fumaric acid and glycols. These resins can contain higher percentages of reactive diluents than ortho resins do.

(3) Bisphenol A fumarates: These are based on ethoxylated bisphenol A and fumaric acid.

(4) HET acid resins (hexachloroendomethylenetetrahydrophthalic acid resins): These are resins obtained from anhydrides containing chlorine/bromine or phenols when producing unsaturated polyester resins.

In addition to those resin classes, the so-called dicyclopentadiene resins (DCPD resins) can be distinguished as unsaturated polyester resins. The class of DCPD resins is obtained either through modification of one of the aforementioned resin types by means of the Diels-Alder reaction with cyclopentadiene, or they are alternatively obtained through an initial reaction of a dicarbonic acid—e.g., maleic acid, with dicyclopentadienyl—and subsequently through a second reaction, the customary production of an unsaturated polyester resin, with the latter being referred to as a DCPD-maleate resin.

The unsaturated polyester resin preferably has a molecular weight Mn in the range of 500 to 10,000 Dalton, more preferably in the range of 500 to 5,000 and even more preferably in the range of 750 to 4,000 (according to ISO 13885-1). The unsaturated polyester resin has an acid value in the range of 0 to 80 mg KOH/g resin, preferably in the range of 5 to 70 mg KOH/g resin (according to ISO 2114-2000). If a DCPD resin is used as an unsaturated polyester resin, the acid value is preferably 0 to 50 mg KOH/g resin.

In the sense of the invention, vinyl ester resins are oligomers, prepolymers, or polymers having at least one (meth)acrylate end group, so-called (meth)acrylate-functionalized resins, which also includes urethane(meth)acrylate resins and epoxy(meth)acrylates.

Vinyl ester resins that have unsaturated groups only in the end position are, for example, obtained through the transformation of epoxide oligomers or polymers (e.g., bisphenol A digylcidyl ether, phenol novolak-type epoxides, or epoxide oligomers based on tetrabrombisphenol A) containing (meth)acrylic acid or (meth)acrylamide for example. Preferred vinyl ester resins are (meth)acrylate-functionalized resins and resins obtained through the transformation of an epoxide oligomer or polymer with methacrylic acid or methacrylamide, preferably with methacrylic acid. Examples of compounds of this kind are known from the publications U.S. Pat. No. 3,297,745 A, U.S. Pat. No. 3,772,404 A, U.S. Pat. No. 4,618,658 A, GB 2 217 722 A1, DE 37 44 390 A1, and DE 41 31 457 A1.

Particularly appropriate and preferred as vinyl ester resin are (meth)acrylate-functionalized resins that are obtained, for example, through transformation of di- and/or higher-functional isocyanates with appropriate acryl compounds, optionally with the help of hydroxy compounds containing at least two hydroxyl groups, as described, for example, in DE 3940309 A1.

Aliphatic (cyclic or linear) and/or aromatic di- or higher-functional isocyanates or prepolymers thereof can be used as isocyanates. The use of such compounds serves to increase wetting ability and thus to improve adhesion properties. Aromatic di- or higher-functional isocyanates or prepolymers thereof are preferred, with aromatic di- or higher-functional prepolymers being particularly preferred. Toluylene diisocyanate (TDI), methylene diphenyl diisocyanate (MDI), and polymeric methylene diphenyl diisocyanate (pMDI) to increase chain stiffening and hexamethylene diisocyanate (HDI) and isophoronediisocyanate (IPDI), which improves flexibility, can be mentioned as examples, with polymeric methylene diphenyl diisocyanate (pMDI) being very particularly preferred.

Acrylic acid and acrylic acids substituted on hydrocarbyl, such as methacrylic acid, hydroxyl-group-containing esters of acrylic or methacrylic acid with multivalent alcohols, pentaerythrittritol(meth)acrylate, glycerol di(meth)acrylate, such as trimethylolpropane(meth)acrylate, [and] neopentylglycol mono(meth)acrylate are appropriate as acryl compounds. Acrylic and methacrylic acid hydroxylalkyl esters, such as hydroxyethyl(meth)acrylate, hydroxypropyl(meth)acrylate, [and] polyoxyethylene(meth)acrylate, polyoxypropylene(meth)acrylate, are preferred, particularly since compounds of this kind promote the steric prevention of the saponification reaction.

Bivalent or higher-valent alcohols, such as reaction products of ethylene or propylene oxide, such as ethanediol, di- or triethylene glycol, propanediol, dipropylene glycol, other diols, such as 1,4-butanediol, 1,6-hexanediol, neopentyl glycol, diethanolamine, also bisphenol A or F or ethox/propoxylation or hydration or halogenation products thereof, higher-valent alcohols, such as glycerin, trimethylolpropane, hexanetriol, and pentaerythritol, hydroxyl-group-containing polyethers, for example oligomers of aliphatic or aromatic oxiranes and/or higher cyclic ethers, such as ethylene oxide, propylene oxide, styrene oxide and furane, polyethers that contain aromatic structural units in the main chain, such as those of bisphenol A or F, hydroxyl-group-containing polyesters based on the aforementioned alcohols or polyethers and dicarbonic acids or their anhydrides, such as adipinic acid, phthalic acid, tetra- or hexahydrophthalic acid, HET acid, maleic acid, fumaric acid, itaconic acid, sebacinic acid, and the like are appropriate as hydroxyl compounds that can optionally be added. Hydroxy compounds having structural units for chain stiffening of the resin, hydroxy compounds that contain unsaturated structural units, such as fumaric acid, to increase cross-linking density, branched or star-shaped hydroxy compounds, particularly tri- or higher-valent alcohols and/or polyethers or polyesters, which contain their structural units, branched or star-shaped urethane(meth)acrylate to achieve lower viscosity of the resins or their solutions in reactive diluents and higher reactivity and cross-linking density are particularly preferred.

The vinyl ester resin preferably has a molecular weight Mn in the range of 500 to 3,000 Dalton, more preferably 500 to 1,500 Dalton (according to ISO 13885-1). The vinyl ester resin has an acid value in the range of 0 to 50 mg KOH/g resin, preferably in the range of 0 to 30 mg KOH/g resin (according to ISO 2114-2000).

All of these resins that can be used in accordance with the invention can be modified according to the method known to those skilled in the art, in order, for example, to obtain lower acid numbers, hydroxide numbers, or anhydride numbers; or can be made more flexible by inserting flexible units in the base structure, and the like.

The resin can also contain other reactive groups, which can be polymerized using the initiator system in accordance with the invention—for example, reactive groups that are derived from itaconic acid, citraconic acid, and allylic groups, and the like.

In a preferred embodiment of the invention, the reaction-resin composition contains additional low-viscous, radically polymerizable compounds as reactive diluents for the radically polymerizable compound, in order to adjust its viscosity, if necessary.

Appropriate reactive diluents are described in the publications EP 1 935 860 A1 and DE 195 31 649 A1. The resin mixture preferably contains a (meth)acrylic acid ester as reactive diluent, with (meth)acrylic acid esters preferably being chosen from the group consisting of hydroxypropyl(meth)acrylate, propanediol-1,3-di(meth)acrylate, butanediol-1,2-di(meth)acrylate, trimethylolpropane tri(meth)acrylate, 2-ethylhexyl(meth)acrylate, phenylethyl(meth)acrylate, tetrahydrofurfuryl(meth)acrylate, ethyltriglycol(meth)acrylate, N,N-dimethylaminoethyl(meth)acrylate, N,N-dimethylaminomethyl(meth)acrylate, butanediol-1,4-di(meth)acrylate, acetoacetoxyethyl(meth)acrylate, ethanediol-1,2-di(meth)acrylate, isobornyl(meth)acrylate, diethylene glycol di(meth)acrylate, methoxypolyethylene glycol mono(meth)acrylate, trimethylcyclohexyl(meth)acrylate, 2-hydroxyethyl(meth)acrylate, dicyclopentenyl oxyethyl(meth)acrylate and/or tricyclopentadienyl di(meth)acrylate, bisphenol A-(meth)acrylate, novolak epoxy di(meth)acrylate, di[(meth)acryloyl-maleoyl]-tricyclo-5.2.1.0.^{2,6}-decane, dicyclopentenyl oxyethyl crotonate, 3-(meth)acryloyl-oxymethyl-tricylo-5.2.1.0.^{2,6}-decane, 3-(meth)cyclopentadienyl(meth)acrylate, isobornyl(meth)acrylate, and decalyl-2-(meth)acrylate.

As a matter of principle, other common radically polymerizable compounds, alone or in a mixture with the (meth)acrylic acid esters, can be used—e.g., styrene, α-methylstyrene, [and] alkylate styrenes such as tert-butylstyrene, divinylbenene, and allyl compounds.

In a further embodiment of the invention, the reaction-resin composition also contains an inhibitor.

The stable radicals commonly used as inhibitors for radically polymerizable compounds, such as N-oxyl radicals, as known to those skilled in the art, are suitable as inhibitor for the storage stability of the radically polymerizable compound and thus also of the resin component, as well as for adjustment of the gel time.

Phenolic inhibitors, as otherwise commonly used in radically curable resin compositions, cannot be used here, because the inhibitors, as reducing agents, would react with the copper(II) salt, which would have an adverse effect on storage stability and gel time.

N-oxyl radicals such as those described in DE 199 56 509 A1 can be used, for example. Appropriate stable n-oxyl-radicals (nitroxyl radicals) can be chosen from among 1-oxyl-2,2,6,6-tetramethylpiperidine, 1-oxyl-2,2,6,6-tetramethylpiperidine-4-ol (also called TEMPOL), 1-oxyl-2,2,6,6-tetramethylpiperidine-4-on (also called TEMPON), 1-oxyl-2,2,6,6-tetramethyl-4-carboxyl-piperidine (also called 4-carboxy-TEMPO), 1-oxyl-2,2,5,5-tetramethyl pyrrolidine, 1-oxyl-2,2,5,5-tetramethyl-3-carboxyl pyrrolidine (also called 3-carboxy-PROXYL), aluminum-N-nitroso phenylhydroxylamine, [and] diethylhydroxylamine. Other appropriate N-oxyl compounds are oximes such as acetaldoxime, acetone oxime, methyl ethyl ketoxime, salicyloxime, benzoxime, glyoxime, dimethylglyoxime, acetone-O-(benzyloxycarbonyl)oxime; or indoline-nitroxide radicals such as 2,3-dihydro-2,2-diphenyl-3-(phenylimino)-1H-indole-1-oxyl nitroxide; or β-phosphorylated nitroxide radicals such as 1-(diethoxyphosphinyl)-2,2-dimethylpropyl-1,1-dimethylmethyl-nitroxide, and the like.

The reaction-resin composition can also contain inorganic aggregates, such as fillers and/or other additives.

The customary fillers, preferably mineral or mineral-like fillers, such as quartz, glass, sand, quartz sand, quartz powder, porcelain, corundum, ceramic, talcum, silicic acid (e.g., pyrogenic silicic acid), silicates, clay, titanium dioxide, chalk, barite, feldspar, basalt, aluminum hydroxide, granite or sandstone, polymeric fillers (such as duroplasts), hydraulically curable fillers (such as gypsum), quicklime or cement (e.g., alumina cement or Portland cement), metals (such as aluminum), carbon black, also wood, mineral or organic fibers, or the like, or mixtures of two or more of them, which can be added as powder, in grain form or in the form of molded bodies, are used as fillers. The fillers may be present in any chosen form, for example as powder or meal, or as molded bodies—e.g., in cylinder, ring, sphere, plate, rod, saddle, or crystal shape, or also in fiber shape (fibrillary fillers)—and the corresponding base particles preferably have a maximum diameter of 10 mm. However, the globular, inert substances (sphere shape) are preferred and are much more reinforcing.

Conceivable additives are thixotropic agents such as, where applicable, post-treated pyrogenic silicic acid, bentonites, alkyl- and methylcelluloses, ricin oil derivatives or the like, softeners (such as phthalic acid or sebacinic acid esters), stabilizers, antistatic agents, thickeners, flexibilizers, curing catalysts, rheology modifiers, wetting agents, color-imparting additives (such as coloring agents or, in particular, pigments, for example, for differently dyeing the components to allow better control of mixing them) or the like, or mixtures of two or more of them are possible. Non-reactive diluents (solvents) can also be present, such as lower alkyl ketones (e.g., acetone), di-lower alkyl-lower-alkanoylamides (such as dimethylacetamide), lower alkyl alkylbenzenes (such as xylenes or toluene), phthalic acid esters or paraffins, water, or glycols. Metal scavengers in the form of surface-modified pyrogenic silicic acids can also be contained in the reaction-resin composition.

In that respect, reference is made to the publications WO 02/079341 A1 and WO 02/079293 A1, as well as WO 2011/128061 A1, whose content is hereby incorporated into this application.

In order to provide a storage-stable system, as mentioned above, the copper(I) complex is first produced in situ—i.e., when mixing the corresponding reactants—from an appropriate copper(II) salt, the nitrogen-containing ligand, and an appropriate reducing agent. Accordingly, it is necessary to separate the copper(II) salt and the reducing agent from each other in a reaction-inhibiting manner. This is usually done by storing the copper(II) salt in a first component and the reducing agent in a second component separate from the first component.

Accordingly, a further object of the invention is a two- or multicomponent system, which contains the described reaction-resin composition.

In one embodiment of the invention, the components of the reaction-resin composition are spatially disposed in such a way that the copper(II) salt and the reducing agent are separated from each other—i.e., each in a component disposed separately from each other. This prevents the formation of the reactive species, namely the reactive copper(I) complex, and thus the polymerization of the radically polymerizable compound from starting during storage.

Also separating the initiator from the copper(II) salt is preferred as well, because it cannot be excluded that small quantities of copper(I) salt are present, since the copper(II) salt can be in equilibrium with the corresponding copper(I) salt, which, together with the initiator, could cause gradual initiation. This would lead to premature at least partial polymerization (gelling) of the radically polymerizable compound and thus to reduced storage stability.

Further, this would have a negative impact on the preadjusted gel time of the composition, which would be expressed in a gel-time drift. This has the advantage of making it possible to do without the use of highly pure and thus very expensive copper(II) salts.

In that regard, the initiator can be stored together with the reducing agent in one component, as in a two-component system, or as an independent component, as in a three-component system.

The inventors have observed that an intense reaction takes place in the case of specific nitrogen-containing ligands, particularly when using methacrylates as radically polymerizable compounds, including in the absence of initiator and reducing agent. This appears to occur when a ligand having tertiary amino groups is involved and the ligand contains an alkyl residue having α-H atoms.

Depending on the choice of the nitrogen-containing ligands, the ligand and the copper(II) salt can be contained storage-stably in one component, particularly in the case of the preferred amines having primary amino groups.

One preferred embodiment relates to a two-component system containing a reaction-resin composition, which includes a radically polymerizable compound, an α-halocarboxylic acid ester, a copper(II) salt, a nitrogen-containing ligand, a reducing agent, an inhibitor, optionally at least one reactive diluent, and optionally inorganic aggregates. In that regard, the copper(II) salt and the nitrogen-containing ligand are contained in a first component, the A component; and the α-halocarboxylic acid ester and the reducing agent are contained in a second component; the B component, with the two components being stored separately from each other in order to prevent a reaction of the components among themselves before mixing. The radically polymerizable compound, the inhibitor, the reactive diluent, and the inorganic aggregates are divided between the A and B component[s].

The reaction-resin composition can be contained in a cartridge, a drum, a capsule, or a foil bag that includes two or more chambers, which are separated from each other and in which the copper(II) salt and the reducing agent, or the copper(II) salt and the reducing agent as well as the ligand, are contained separately from each other in a reaction-inhibiting manner.

The reaction-resin composition in accordance with the invention is primarily used in the construction sector, for example to repair concrete, as polymer concrete, as coating mass based on synthetic resin or as cold-curing road marking. They are [sic] particularly suitable for chemically fixing anchoring elements such as anchors, reinforcing bars, screws, and the like, [and] in bore holes, particularly in bore holes in different substrates, particularly mineral substrates such as those based on concrete, pore concrete, brickwork, calcareous sandstone, sandstone, natural stone, and the like.

A further object of the invention is the use of the reaction-resin composition as a binding agent, particularly to fasten anchoring means in bore holes in different substrates and for construction adhesion.

The present invention also relates to the use of the reaction-resin mortar composition defined above for construction purposes, including the curing of the composition by mixing the copper(II) salts with the reducing agent or the copper(II) salts with the reducing agent and the ligand.

More preferably, the reaction-resin mortar composition in accordance with the invention is used for fastening threaded anchor rods, reinforcing bars, threaded sleeves, and screws in bore holes in different substrates, including mixing the copper(II) salt with the reducing agent or the copper(II) salt with the reducing agent and the ligand; placement of the mixture into the bore hole; introduction of the threaded anchor rods, the reinforcing iron, the threaded sleeves, and the screws into the mixture in the bore hole; and curing of the mixture.

The invention is explained in greater detail in reference to a series of examples and comparative examples. All examples support the scope of the claims. However, the invention is not limited to the specific embodiments shown in the examples.

### EXEMPLARY EMBODIMENTS

The following components were used to produce the example formulations below.

| Abbreviation | Name |
|---|---|
| UMA prepolymer | A prepolymer produced from MDI and HPMA |
| | according to DE 4111828; diluted with 35% by weight |
| | BDDMA |
| MDI | Diphenylmethane diisocyanate |
| BDDMA | 1,4-butanediol dimethacrylate |
| HPMA | Hydroxypropyl methacrylate |
| THFMA | Tetrahydrofurfuryl methacrylate |
| BiBEE | α-bromo-iso-butyric acid ester |
| BiEM | 2-(2-bromoisobutyryloxy) ethyl methacrylate |
| BiDipenta | Dipentaerythritol hexakis(2-bromoisobutyrate) |
| BiE | Ethylene-bis(2-bromoisobutyrate) |
| BiPenta | Pentaerythritol-tetrakis(2-bromoisobutyrate) |
| Bipy | 2,2′-bipyridine |
| PMDETA | N,N,N′,N″,N″-pentamethyl-diethyl-enetriamine |
| phen | 1,10-phenanthroline |
| HMTETA | 1,1,4,7,10,10-hexamethyl triethylenetetramine |
| Me6TREN | (Tris[2-(dimethylamino)ethyl]amine) |
| TPMA | (Tris(2-pyridylmethyl)amine) |
| DMbipy | 6,6-Dimethyl-2,2-dipyridyl |
| Sn-octoate | Sn(II) ethylhexanoate |
| VC6P | Ascorbic acid-6-palmitate |
| Fe 7/8 | Octa-soligen Iron 7 |
| TEMPOL | 4-hydroxy-2,2,6,6-tetramethylpiperidine oxyl |

### Examples 1 to 7

To evaluate the applicability of the initiator system to cold-curing methacrylate esters and the possibility of adjusting the gel time using an inhibitor, model mixtures were produced from one monomer, initially without UMA prepolymer.

### Production of Model Mixtures

The Cu salt and, where applicable, the inhibitor are dissolved in a polypropylene beaker in the monomer, optionally while heating. The ligands and the initiator are dissolved in the homogeneous solution at room temperature. As soon as there is a homogeneous solution, the polymerization is started by adding the reducing agent (stir in vigorously for 30 seconds). The respective quantities that are used are listed in Table 1. Table 1 also shows the observation after mixing of all components.

TABLE 1
Composition of the model mixtures in examples 1 to 7 and observations

| | | Example | | | | | | |
|---|---|---|---|---|---|---|---|---|
| | | 1 | 2 | 3 | 4 | 5 | 6 | 7 |
| Monomer | BDDMA | 25 g | 25 g | 25 g | 12.33 g | 12.33 g | 12.33 g | 12.33 g |
| | HPMA | | | | 12.33 g | 12.33 g | 12.33 g | 12.33 g |
| | THFMA | | | | 12.33 g | 12.33 g | 12.33 g | 12.33 g |
| Cu salt | Cu(II)ethyl | 0.1 g | 0.1 g | 0.1 g | 0.1 g | 0.1 g | 0.1 g | 0.1 g |
| | hexanoate | | | | | | | |
| Initiator | BiBEE | 0.35 g | 0.35 g | 0.056 g | | | | |
| | BiEM | | | | 0.086 g | | | |
| | BiDipenta | | | | | 0.086 g | | |
| | BiE | | | | | | 0.055 g | |
| | BiPenta | | | | | | | 0.056 g |
| Ligand | PMDETA | 0.12 g | 0.12 g | 0.12 g | | | | |
| | bipy | | | | 0.04 g | 0.04 g | 0.04 g | 0.04 g |
| Reducing agent | Sn-octoate | 0.12 g | 0.12 g | 0.12 g | 0.12 g | 0.12 g | 0.12 g | 0.12 g |
| Inhibitor | TEMPOL | — | 0.01 g | 0.01 g | — | — | — | — |
| Observation¹⁾ | Polymerization | 4 min²⁾ | 15 min⁴⁾ | approx. | 3 min | 3.5 min | 2.5 min | 2.5 min |
| | after | 6 min³⁾ | 16 min⁵⁾ | 50 min | | | | |
| | Heat | | | clear | (168° C.), | (167° C.), | (169° C.), | (168° C.), |
| | development | | | | | | | |

¹⁾A glassy-brittle, hard polymer is formed in all cases.
²⁾Intense polymerization
³⁾Completed
⁴⁾Heat development and gelling
⁵⁾Intense polymerization

Example 3 was used as a basis for the determination of gel time and pull-out resistance. For that purpose, a model mixture containing four times the quantity of the components for example 3 which are shown in Table 1 was produced, and the gel time and the pull-out resistance as described below were determined.

### Determination of Gel Time

The gel time of the model mixtures is determined using a commercially-available device (GELNORM® gel timer) at a temperature of 25° C. All components are mixed and, immediately after mixing, tempered in the silicone bath at 25° C. and the temperature of the sample is measured. The sample itself is contained in a test tube, which is set into an air jacket immersed in the silicone bath for tempering.

The heat development of the sample is plotted over time. The analysis is done according to DIN16945. The gel time is the time taken for a 10K temperature increase, in this case from 25° C. to 35° C.
Time to 35° C.: 22.5 minutes
Time to peak: 27 minutes
Peak temperature: 183° C.

### Determination of Pull-Out Resistance

An M8 threaded steel rod is placed in a steel sleeve having a 10-mm internal diameter and interior threading, embedding depth 40 mm, set with the mixture and after 24 hours at room temperature pulled out at 3 mm/min until failure on the tensile test machine, and the mean values of 5 measurements were recorded:
Maximum bond strength: 18.9±0.90 N/mm²
Displacement at failure: 1.13±0.08 mm

Based on examples 1 to 3, it is apparent that, using the model mixtures, an intense and fast polymerization of methacrylates is achieved at room temperature, which can be delayed using an inhibitor and also results in good polymerization (peak temperature approximately 180° C.) even after a long open time (gel time approximately 22 minutes), as well as leading to remarkable mechanical properties (bond strength approximately 19 N/mm² with only slight displacement). This indicates that it is possible, using the compositions in accordance with the invention, to deliberately adjust the gel time and adapt to the respective application requirements.

Examples 1 and 4 to 7 clearly show that polymerization can be satisfactorily induced using various initiators at room temperature.

### Examples 8 to 10

The model mixtures are produced analogously to examples 1 to 7, with different concentrations of inhibitor being added.

The following examples show that it is possible to delay the start of polymerization by adding an appropriate inhibitor, thereby controlling the gel time of a model mixture by means of the quantity of inhibitor that is added.

TABLE 2
Composition of the model mixtures in examples 8 to 10

| | | Example | | |
|---|---|---|---|---|
| | | 8 | 9 | 10 |
| Monomer | BDDMA | 12.5 g | 12.5 g | 12.5 g |
| | HPMA | 16.0 g | 16.0 g | 16.0 g |
| Cu salt | Cu(II)ethyl | 0.10 g | 0.10 g | 0.10 g |
| | hexanoate | | | |
| Initiator | BiBEE | 0.06 g | 0.06 g | 0.06 g |
| Ligand | PMDETA | 0.03 g | 0.03 g | 0.03 g |
| Reducing agent | Sn(II)ethyl | 0.12 g | 0.12 g | 0.12 g |
| | hexanoate | | | |
| Inhibitor | TEMPOL | — | 0.005 g | 0.01 g |

In example 8, strong polymerization began after 5 minutes, and in example 9 it began after 11 minutes, while the polymerization in example 10 was too strongly inhibited and no polymerization was observed.

Examples 8 to 10 thus show that the start of polymerization can be controlled as a result of the quantity of inhibitor and that it comes to a standstill at high inhibitor concentrations.

### Examples 11 to 19

The model mixtures are produced analogously to examples 1 to 7, with additional reducing agents (examples 11 and 12) or different ligands (examples 13-19) being used. The compositions are shown in Table 3.

TABLE 3
Composition of the model mixtures in examples 11, 13, and 14 and the resin
mixtures in accordance with the invention of examples 12 and 15 to 19

| | | Example | | | | | | | | |
|---|---|---|---|---|---|---|---|---|---|---|
| | | 11 | 12 | 13 (1) | 14 | 15 | 16 | 17 | 18 | 19 |
| Monomer | BDDMA | 25.0 g | 5.3 g | 25.0 g | 12.5 g | 5.25 g | 5.25 g | 5.25 g | 5.25 g | 5.25 g |
| | HPMA | | 11.4 g | | 16.0 g | 11.4 g | 11.4 g | 11.4 g | 11.4 g | 11.4 g |
| | UMA prepol. | | 17.5 g | | | 17.5 g | 17.5 g | 17.5 g | 17.5 g | 17.5 g |
| Cu salt | Cu(II)ethyl | 0.10 g | 0.10 g | 0.10 g | 0.10 g | 0.10 g | 0.10 g | 0.10 g | 0.10 g | 0.10 g |
| | hexanoate | | | | | | | | | |
| Initiator | BiBEE | 0.06 g | 0.06 g | 0.35 g | 0.06 g | 0.06 g | 0.06 g | 0.06 g | 0.06 g | 0.06 g |
| Ligand | PMDETA | 0.03 g | | 0.12 g | | | | | | |
| | Bipy | | 0.025 g | | 0.01 g | | | | | |
| | Phen | | | | | 0.02 g | | | | |
| | HMTETA | | | | | | 0.03 g | | | |
| | Me6TREN | | | | | | | 0.059 g | | |
| | TPMA | | | | | | | | 0.075 g | |
| | DMbipy | | | | | | | | | 0.048 g |
| Reducing | Fe 7/8 | 0.1 g | | | | | | | | |
| agent | Vc6P | | 0.16 g | | | | | | | |
| | Sn-octoate | | | 0.12 g | 0.12 g | 0.12 g | 0.12 g | 0.12 g | 0.12 g | 0.12 g |
| Inhibitor | TEMPOL | — | — | — | — | — | — | — | — | — |
| Commentary⁶⁾ | Polymerization | 45 sec | 8 min | 45 s | 11 min | 10 min | 7 min | 16 min | 6.5 min | approx 1.5 h |
| | after | | | | | | | | | |
| | Heat | strong | 160° C. | strong | 172° C. | 165° C. | 167° C. | 159° C. | 158° C. | approx |
| | development | | | | | | | | | 130° C. |

⁶⁾A hard and brittle poymer is formed in all cases

Examples 11 to 19 clearly show that various amines, such as 2,2′-bipyridine and 1,10-phenanthroline, are appropriate as ligands for the composition in accordance with the invention. As shown by a comparison of example 1 with examples 14 and 15, the start of polymerization and thus the gel time can also be influenced by means of the quantity of ligand.

### Examples 20 to 22

Inorganically filled two-component systems having the compositions shown in Table 4 are produced and various properties of the contained masses are investigated.

The two components A and B are initially produced separately by first dissolving the respective components of the initiator system shown in Table 4 in the monomer mixture; then the filler and the additive are stirred in, with pasty, flowable components being obtained. Curing is started by thoroughly mixing the two components A and B.

TABLE 4
Composition of the model mixtures of examples 20 and 21 and of example 22 in
accordance with the invention

| | | | Example | | |
|---|---|---|---|---|---|
| | | | 20 | 21 | 22 |
| A components | Monomers | BDDMA | 6.5 g | 6.25 g | 47 g |
| | | HPMA | 8.0 g | 8.01 g | 100 g |
| | | UMA-prepol | | | 155 g |
| | Cu salt | Cu(II)ethyl hexanoate | 0.1 g | 0.10 g | 1.11 g |
| | Initiator | BiBEE | | 0.06 g | 3.95 g |
| | Ligand | PMDETA | | 0.025 g | 0.44 g |
| | | 2,2′-bipy | | | |
| | Filler | Millisil W2⁷⁾ | 16.0 g | 16.0 g | 138 g |
| | | Quartz sand F32⁸⁾ | | | 288 g |
| | Additive | Cab-O-Sil TS-720⁹⁾ | 0.9 g | 0.9 g | 18.7 g |
| B components | Monomers | BDDMA | 6.5 g | 6.0 g | 46 g |
| | | HPMA | 8.0 g | 8.0 g | 99.5 g |
| | | UMA-prepol | | | 153 g |
| | Initiator | BiBEE | 0.06 g | | |
| | Ligand | PMDETA | 0.03 g | | |
| | Reducing means | Sn(II)ethyl hexanoate | 0.12 g | 0.12 g | 8.2 g |
| | Inhibitor | TEMPOL | | | 0.01 g |
| | Filler | Millisil W12 | 16.0 g | 16.0 g | 136 g |
| | | Quartz sand F32 | | | 285 g |
| | Additive | Cab-O-Sil TS-720 | 0.9 g | 0.9 g | 18.5 g |

⁷⁾Quartz powder; mean grain size 16 μm
⁸⁾Quartz sand; mean grain size 0.24 mm
⁹⁾Pyrogenic amorphous silicic acid

The composition from example 20 cures into a hard, gray mass after approximately 9 minutes, with strong heat development. The composition from example 21 cures after 5 minutes, with strong heat development (144° C.).

To determine various properties of an inorganically filled reaction-resin composition in accordance with the invention, the components of example 22 are added to a double cartridge having the volume ratio A:B=3:1 and discharged for the measurements using a commercially-available static mixer.

The gel time of the mass obtained in this way was determined according to the description above:
Time to 35° C.: 2.5 minutes
Time to peak: 3.3 minutes
Peak temperature: 112° C.

### Pull-Out Resistance—Steel Sleeve

An M8 threaded steel rod is place in a steel sleeve having a 10-mm internal diameter and interior threading, embedding depth 40 mm, with the mixture, and after 24 hours at room temperature is pulled out at 3 mm/min until failure on the tensile test machine:
Bond strength: 26.3 N/mm²
Displacement: 0.97 mm
   Pull-Out Tests from Concrete

Three M12×72 anchor rods each are placed in concrete in dried and cleaned boreholes having a diameter of 14 mm and after curing for 24 h are pulled out until failure and the following failure loads are determined:
Room temperature: 28.9±3.2 kN
−5° C.: 10.4±2.3 kN
+40° C.: 34.4±5.8 kN
   Adhesion Pull-Off Tests from Concrete

Metal stamps having a diameter of 50 mm are bonded to cut, dry concrete surfaces using a 1-mm thick layer of the mass and after 24 h at room temperature the adhesion pull-off values are determined (mean value of 2 measurements):
Adhesion pull resistance 1.8 N/mm²

Examples 20 to 22 show that polymerization and thus curing of the mass occurs at room temperature in filled systems, as well. Accordingly, the reaction-resin composition in accordance with the invention is appropriate for the provision of peroxide-free radically curable adhesives, plugging masses, molding masses, and the like.

1. A reaction-resin composition having a resin component which contains a radically polymerizable compound and having an initiator system which contains an α-halocarboxylic acid ester and a catalyst system that comprises a copper(I) salt and at least one nitrogen-containing ligand.

2. Reaction-resin composition in accordance with claim 1, wherein the α-halocarboxylic acid ester is chosen from among compounds having the general formula (I): 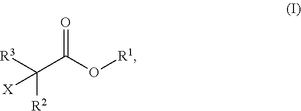
in which
X means chlorine, bromine, or iodine, preferably chlorine or bromine, particularly preferably bromine;
R¹ stands for a straight-chain or branched, optionally substituted C₁-C₂₀ alkyl group or an aryl group; or
for the residue of an acylated, branched trivalent alcohol, the residue of a completely or partially acylated, linear or branched, quadrivalent alcohol, the residue of a completely or partially acylated, linear pentavalent or hexavalent alcohol, the residue of a completely or partially acylated, linear or cyclical C₄-C₆ aldose or C₄-C₆ ketose or the residue of a completely or partially acylated disaccharide, and isomers of those compounds;
R² and R³, independently of each other, stand for hydrogen, a C₁-C₂₀ alkyl group, a C₃-C₈ cycloalkyl group, C₂-C₂₀ alkenyl or alkinyl group, oxiranyl group, glycidyl group, aryl group, heterocyclyl group, aralkyl group, or aralkenyl group.

3. Reaction-resin composition in accordance with claim 2, wherein the α-halocarboxylic acid ester is a C₁-C₆ alkyl ester of an α-halo-C₁-C₆-carboxylic acid.

4. Reaction-resin composition in accordance with claim 3, wherein the α-halo-C₁-C₆-carboxylic acid is an α-bromo-C₁-C₆-carboxylic acid.

5. Reaction-resin composition in accordance with claim 1, wherein the copper(I) salt is formed in situ from a copper(II) salt and a reducing agent.

6. Reaction-resin composition in accordance with claim 5, wherein the copper(II) salt and the reducing agent are separated from each other in a reaction-inhibiting manner.

7. Reaction-resin composition in accordance with claim 1, wherein the copper(II) salt is soluble in organic solvents.

8. Reaction-resin composition in accordance with claim 7, wherein the copper(II) salt is chosen from the group comprising Cu(II)(PF₆)₂, CuX₂, where X=Cl, Br, I, Cu(OTf)₂ and Cu(II) carboxylates.

9. Reaction-resin composition in accordance with claim 1, wherein the reducing agent is selected from the group consisting of chosen from the group comprising ascorbic acid and its derivatives, tin(II) carboxylates, and phenolic reducing agents.

10. Reaction-resin composition in accordance with claim 1, wherein the nitrogen-containing ligand contains two or more nitrogen atoms and can form a chelate complex with copper(I).

11. Reaction-resin composition in accordance with claim 10, wherein the nitrogen-containing ligand is chosen from among amino compounds having at least two primary, secondary, and/or tertiary amino groups or amino compounds having at least two heterocyclic nitrogen atoms.

12. Reaction-resin composition in accordance with claim 10, wherein the nitrogen-containing ligand is present in excess.

13. Reaction-resin composition in accordance with claim 1, wherein the radically polymerizable composition is an unsaturated polyester resin, a vinyl ester resin, and/or a vinyl ester-urethane resin.

14. Reaction-resin composition in accordance with claim 1, wherein the radically polymerizable compound is a (meth)acrylate-functionalized resin and the α-halocarboxylic acid ester is an α-halocarboxylic acid ester of isobutyric acid or propanoic acid

15. Reaction-resin composition in accordance with claim 1, wherein the composition also contains a non-phenolic inhibitor.

16. Reaction-resin composition in accordance with claim 15, wherein the non-phenolic inhibitor is a stable N-oxyl radical.

17. Reaction-resin composition in accordance with claim 1, wherein the resin component also includes at least one reactive diluent.

18. Reaction-resin composition in accordance with claim 1, wherein the composition also contains inorganic aggregates.

19. Reaction-resin composition in accordance with claim 18, wherein the inorganic aggregate is an additive and/or a filler.

20. Two- or multicomponent system comprising a reaction-resin composition in accordance with claim 1.

21. Two-component system in accordance with claim 20, wherein the copper(II) salt and the nitrogen-containing ligand are contained in a first component and the α-halocarboxylic acid ester and the reducing agent are contained in a second component, the radically polymerizable compound and the inhibitor are divided between the two components, and the two components are separated from each other in a reaction-inhibiting manner.

22. Two-component system in accordance with claim 21, wherein the reaction-resin composition also comprises at least one reactive diluent and/or inorganic aggregates, which are contained in one or both components.

23. Use of a reaction-resin composition in accordance with claim 1 or use of a two- or multicomponent system in accordance with any of the claims for construction purposes.
